(19) United States
(12) Patent Application Publication
(10) Pub. No.: US 2025/0190700 A1
(43) Pub. Date: Jun. 12, 2025

(54) LEVERAGING GENERATIVE LANGUAGE MODELS FOR INTERACTIVE CONSTRAINT SATISFACTION

(71) Applicant: Microsoft Technology Licensing, LLC, Redmond, WA (US)

(72) Inventors: Jin A. SUH, Seattle, WA (US); Bahareh SARRAFZADEH, Seattle, WA (US); Cristina DAESCU, Seattle, WA (US); Shilad Wieland SEN, Minneapolis, MN (US); Connor LAWLESS, Ithaca, NY (US); Jakob SCHOEFFER, Hasloch (DE)

(73) Assignee: Microsoft Technology Licensing, LLC, Redmond, WA (US)

(21) Appl. No.: 18/532,091

(22) Filed: Dec. 7, 2023

(51) Int. Cl. G06F 40/284

(52) U.S. Cl. CPC G06F 40/284

(57) ABSTRACT

The disclosed concepts relate to leveraging a generative language model for interactive constraint solving. For instance, a generative language model can be prompted to generate a constraint data structure that represents a user preference expressed in natural language. The constraint data structure can be parsed to extract constraint parameters that can be programmatically solved by a constraint solver. The generative language model can also be prompted to generate constraint-checking code that can be invoked by the constraint solver.

### BACKGROUND

Traditional algorithms for constraint satisfaction can identify solutions for very complex problems that have many constraints over many variables. However, these algorithms often require that the constraints be specified completely in advance. Furthermore, traditional constraint satisfaction software requires that constraints are expressed programmatically in software-specific data formats that are not readily understood by most users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to constraint satisfaction involving generative language models. One example includes a computer-implemented method that can include receiving natural language inputs from a user, the natural language inputs specifying preferences of the user in natural language. The method can also include generating constraint management prompts for a generative language model, the constraint management prompts being based on the natural language inputs and including instructions requesting that the generative language model generate constraint data structures representing the preferences according to a specified constraint data format. The method can also include inputting the constraint management prompts to the generative language model. The method can also include receiving, from the generative language model, the constraint data structures generated by the generative language model, the constraint data structures being in the specified constraint data format. The method can also include parsing the constraint data structures generated by the generative language model to extract constraint parameters. The method can also include processing the constraint parameters with a constraint solver to identify candidate solutions that satisfy at least some of the constraint parameters. The method can also include outputting the candidate solutions to the user. The method can also include responsive to user input identifying an accepted solution from the candidate solutions, updating a particular data source with the accepted solution.

Another example entails a system that includes a hardware processing unit and a storage resource storing computer-readable instructions. When executed by the hardware processing unit, the computer-readable instructions can cause the system to receive natural language inputs from a user, the natural language inputs specifying preferences of the user in natural language. The computer-readable instructions can also cause the system to generate constraint management prompts for a generative language model, the constraint management prompts being based on the natural language inputs and including instructions requesting that the generative language model generate constraint data structures having constraint parameters representing the preferences of the user. The computer-readable instructions can also cause the system to generate code generation prompts for the generative language model, the code generation prompts instructing the generative language model to generate constraint-checking code that checks whether possible solutions satisfy the constraint parameters. The computer-readable instructions can also cause the system to execute the constraint-checking code with a constraint solver to identify candidate solutions that satisfy at least some of the constraint parameters. The computer-readable instructions can also cause the system to output the candidate solutions to the user. The computer-readable instructions can also cause the system to responsive to user input identifying an accepted solution from the candidate solutions, update a particular data source with the accepted solution.

Another example includes a computer-readable storage medium storing computer-readable instructions which, when executed by a processing unit, cause the processing unit to perform acts. The acts can include receiving natural language inputs from a user, the natural language inputs specifying preferences of the user in natural language. The acts can also include generating constraint management prompts for a generative language model, the constraint management prompts including the preferences and instructions requesting that the generative language model generate constraint data structures representing the preferences according to a specified constraint data format. The acts can also include inputting the constraint management prompts to the generative language model. The acts can also include receiving, from the generative language model, the constraint data structures generated by the generative language model, the constraint data structures being in the specified constraint data format. The acts can also include parsing the constraint data structures generated by the generative language model to extract constraint parameters. The acts can also include processing the constraint parameters with a constraint solver to identify candidate solutions that satisfy at least some of the constraint parameters. The acts can also include outputting the candidate solutions to the user. The acts can also include responsive to user input identifying an accepted solution from the candidate solutions, update a particular data source with the accepted solution.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of a generative language model, consistent with some implementations of the present concepts.

FIG. 2 illustrates an example of user interaction with an interactive constraint satisfaction agent, consistent with some implementations of the present concepts.

FIGS. 3A, 3B, 3C, and 3D illustrate an example of a constraint management prompt template, consistent with some implementations of the present concepts.

FIGS. 4A and 4B illustrate an example of a data checking prompt template, consistent with some implementations of the present concepts.

FIGS. 5A and 5B illustrate an example of a code generation prompt template, consistent with some implementations of the present concepts.

FIGS. 6A and 6B illustrate an example of a suggestion explanation prompt template, consistent with some implementations of the present concepts.

FIGS. 7A, 7B, and 7C illustrate example graphical user interfaces, consistent with some implementations of the present concepts.

FIG. 8 illustrates experimental results obtained using some implementations of the present concepts.

FIG. 9 illustrates an example system, consistent with some implementations of the present concepts.

FIG. 10 illustrates an example method or technique for constraint satisfaction employing a generative language model, consistent with some implementations of the present concepts.

### DETAILED DESCRIPTION

### Overview

As noted above, constraint satisfaction algorithms can identify solutions for complex constraint satisfaction problems involving many constraints over many variables. However, most users are not readily able to express constraints in an appropriate format that can be employed with a traditional constraint solver. Furthermore, constraints such as user preferences can fluctuate over time or in different contexts (e.g., at home vs. in the office), and in fact users may not even be fully aware of all their preferences when initially attempting to complete a task. However, traditional constraint solvers are not adept at extracting user preferences directly from users.

In recent years, generative language models have greatly reduced the amount of user effort in performing complex language tasks, such as generating captions for images or summarizing large documents. Generative language models are also capable of understanding user preferences expressed in natural language. However, despite the great advances in generative language model technology, generative language models can lack proficiency at performing complex constraint satisfaction reasoning over data.

The disclosed implementations can leverage the relative strengths of generative language models and constraint satisfaction algorithms via a hybrid approach that integrates both a generative language model and a constraint solver. For instance, the disclosed implementations can employ a generative language model to receive user preferences in a natural language format and generate constraint data structures that formally represent those preferences in a specific data structure format. The constraint data structures can be parsed to extract constraint parameters that are input to a constraint solver to identify candidate solutions that match the user preferences.

The disclosed implementations can also employ the generative language model to generate constraint-checking code that can be invoked by the constraint solver to check whether a given candidate solution meets a given constraint parameter. Generative language models can also be employed to guide interactions with users, e.g., a generative language model can select actions to take in response to user inputs. The actions can include adding or deleting constraints, changing constraints, suggesting candidate solutions to a user, messaging the user, etc. In this manner, the generative language model can be employed to control the programmatic flow of an interactive constraint satisfaction agent, as described more below.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that is programmed to understand natural language and/or programmed to communicate via natural language. For instance, a language model can be implemented as a neural network, e.g., a decoder-based generative language model such as ChatGPT, BLOOM, PaLM, and/or LLaMA or variants thereof, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. A “generative language model” is a model trained from one or more sources of natural language training data to predict a sequence of output tokens given one or more input tokens. A generative language model can generate new sequences of text given some input prompt, e.g., a query potentially with some additional context. In some cases, a generative language model can be multi-modal, e.g., in addition to textual inputs and/or outputs, the model may be capable of using images, audio or other modalities as inputs and/or generating images, audio, or other modalities as outputs.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query. In some cases, a prompt can include one or more examples for the generative language model as context (e.g., “few-shot prompting), and can condition the generative language model to generate more accurate responses than the generative model would produce without the examples. The term “in-context learning,” as used herein, refers to learning, by a generative model, from examples input to the model at inference time, where the examples enable the generative model to learn without performing explicit training, e.g., without updating model parameters using supervised, unsupervised, or semi-supervised learning.

The term “constraint” refers to any criteria for solving a problem. Constraints can include constraint parameters, e.g., for meetings, the constraint parameters can specify attendees, locations, times, etc. Another type of a constraint parameter is the “priority” of a constraint, which refers to how important the constraint is, e.g., a constraint can be a high-priority constraint, e.g., a mandatory or “hard” constraint. A constraint can also be a lower-priority constraint, e.g., a flexible or “soft” constraint. A constraint solver is a module that solves constraints using a constraint satisfaction algorithm. A constraint solver can identify one or more candidate solutions to a given problem. In some cases, the constraint solver can rank the candidate solutions by weighing them based on their respective priorities. A “data source” is any mechanism that allows data to be stored, updated, retrieved, or deleted. For instance, a data source could be a database, spreadsheet, word processing document, etc., implemented in memory or storage.

The term “machine learning model” refers to any of a broad range of models that can be trained to predict characteristics of input data or generate new data given some input. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

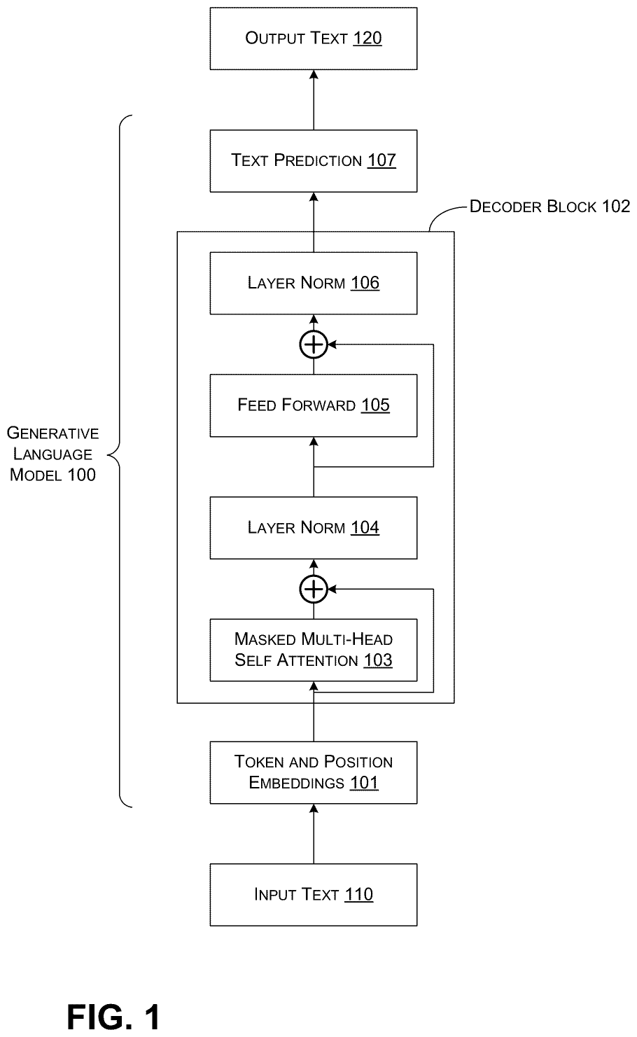

FIG. 1 illustrates an exemplary generative language model 100 that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or computer-based agent. For instance, the input text can include words, sentences, phrases, or other representations of language. The input text can be broken into tokens and mapped to token and position embeddings 101 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 101 are processed in one or more decoder blocks 102. Each decoder block implements masked multi-head self-attention 103, which is a mechanism relating different positions of tokens within the input text to compute the similarities between those tokens. Each token embedding is represented as a weighted sum of other tokens in the input text. Attention is only applied for already-decoded values, and future values are masked. Layer normalization 104 normalizes features to mean values of 0 and variance to 1, resulting in smooth gradients. Feed forward layer 105 transforms these features into a representation suitable for the next iteration of decoding, after which another layer normalization 106 is applied. Multiple instances of decoder blocks can operate sequentially on input text, with each subsequent decoder block operating on the output of a preceding decoder block. After the final decoding block, text prediction layer 107 can predict the next word in the sequence, which is output as output text 120 in response to the input text 110 and also fed back into the language model. The output text can be a newly-generated response to the prompt provided as input text to the generative language model.

Generative language model 100 can be trained using techniques such as next-token prediction or masked language modeling on a large, diverse corpus of documents. For instance, the text prediction layer 107 can predict the next token in a given document, and parameters of the decoder block 102 and/or text prediction layer can be adjusted when the predicted token is incorrect. In some cases, a generative language model can be pretrained on a large corpus of documents and then tuned to a particular use case. For instance, a pretrained generative language model can be tuned using a reinforcement learning technique such as reinforcement learning from human feedback (“RLHF”).

### Scheduling Example

The techniques described herein can be employed to leverage generative language models for interactive constraint satisfaction for a wide range of applications. The following describes one specific implementation where constraints are based on preferences expressed by users in the context of scheduling a meeting.

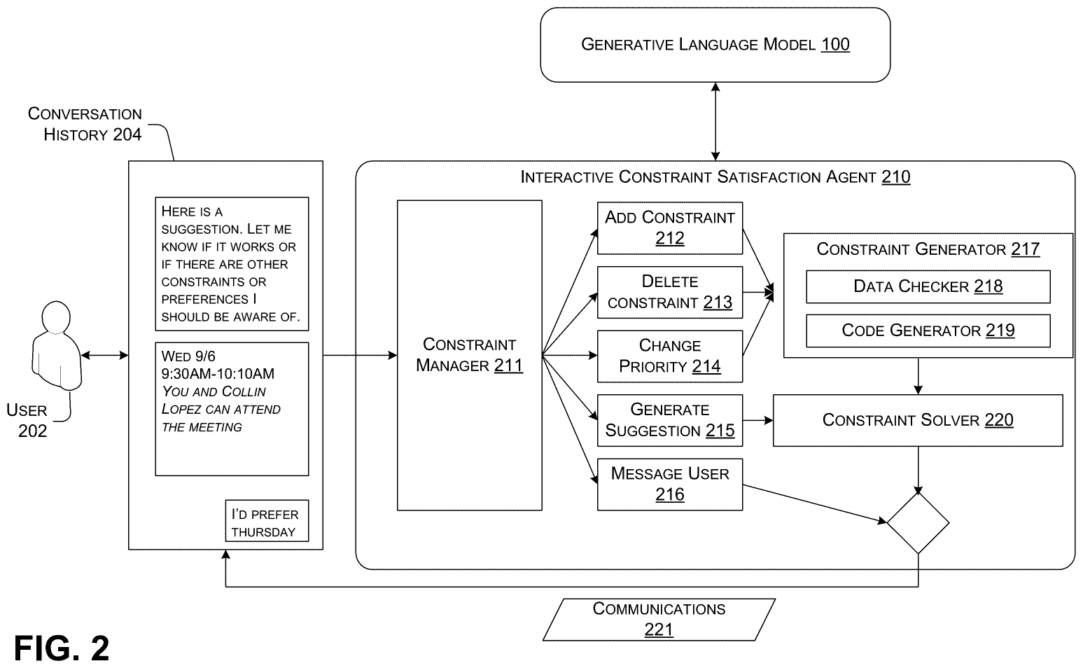

FIG. 2 shows a user 202 and a conversation history 204, where the conversation history involves interactions with an interactive constraint satisfaction agent 210. The interactive constraint satisfaction agent leverages generative language model 100 to interactively solve constraints expressed by the user in natural language. The interactive constraint satisfaction agent includes a constraint manager 211, a constraint generator 217, and a constraint solver 220. The constraint manager can, based on communications from user 202 and output from the generative language model, perform actions such as add constraint 212, delete constraint 213, change priority 214, generate suggestion 215, and/or message user 216. The constraint generator 217 includes a data checker 218 and a code generator 219. The data checker can employ the generative language model to determine whether available data sources allow for a given constraint to be checked. The code generator can employ the generative language model to generate constraint-checking code based on constraints provided by the constraint manager, and provide the constraint-checking code to the constraint solver 220. Communications 221 can be sent to the user to convey either messages from the constraint manager or candidate suggestions provided by the constraint solver.

As described more below, the constraint solver 220 is employed to generate new time suggestions that meet constraint parameters generated by the generative language model 100. The constraint solver performs the mathematical and/or logical reasoning required to find suitable times. Each scheduling preference expressed by user 202 is first translated to a constraint data structure by the generative language model. Then, the constraint data structure is parsed to extract constraint parameters, and the generative language model is employed to generate constraint-checking code that checks whether possible solutions meet individual constraint parameters. For instance, each constraint parameter can be checked by a Python function, e.g., that checks whether a candidate meeting time meets a given preference expressed by a user (i.e., “Not scheduled before 2 pm”). Each constraint data structure also has an associated priority parameter which can represent a priority constraint parameter output by the generative language model. Higher priorities correspond to constraints that are more important. Instead of requiring users to specify an exact numerical priority value for each preference, the interactive constraint satisfaction agent 210 instead keeps an underlying prioritized list of the constraints which are then translated into weights such that constraints with higher priority are satisfied before those of lower priority.

The constraint checking code generated by the generative language model 100 can be invoked by the constraint solver 220. The constraint solver can generate new candidate suggestions that meet some or all of the constraint parameters on the current constraint list. This hybrid framework capitalizes on the benefits of both generative language models and constraint satisfaction algorithms, using a generative language model to flexibly embed natural language scheduling constraints into Python functions and using the constraint solver to generate new time suggestions that are responsive to the current constraints. This occurs within an interactive chat environment which allows the user to express their preferences naturally rather than having to express their preferences as formal constraints suitable for use directly by the constraint solver (e.g., code or logical expressions over variables).

When a user wishes to schedule a meeting, they can first enter information in natural language such as the list of attendees, the duration, and/or the time horizon for the meeting into a form. Once a user enters the information, the constraint solver 220 generates an initial time suggestion that maximizes the availability of the desired attendees. The interactive constraint satisfaction agent 210 returns the initial time suggestion and initiates a chat so that users can interact with the system to refine the suggested meeting time.

For every new chat message entered in the chat, the constraint manager 211 translates the request into an action for the interactive constraint satisfaction agent 210 to take. For instance, the constraint manager can prompt the generative language model 100 with a request to select one of the available actions. One such action is the addition of a new constraint, which involves translating a natural language preference into constraint checking-code as described above. These functions are then used within the constraint solver 220 to generate new time suggestions until the user accepts a suggested time, at which point a meeting can be invited to that user's calendar, as well as the other attendees, at the accepted time.

### Constraint Manager

When a user enters a new chat message, the constraint manager 211 can select an action to take, such as:
Add Constraint: Generates a new scheduling constraint and calls the constraint generator 217.
Change Priority: Changes the priority of an existing constraint on the current constraint list.
Delete Constraint: Removes a given scheduling constraint from the current constraint list.
Message User: Sends a message back to the user.
Generate Suggestion: Calls the constraint solver 220 to generate a new time suggestion and returns it to the user.

In some cases, the constraint manager is given as input the entire chat history between the user and the interactive constraint satisfaction agent 210, and the current list of scheduling constraints. This allows the actions selected by the generative language model 100 to be informed by not only the most recent chat message but the context in which the message is taking place. For instance, if a user tries out a scheduling constraint (e.g., “How about meeting on Thursday?”) and decides against it (e.g., “Ah never mind”) the system is able to remove the correct scheduling constraint without additional follow-up questions.

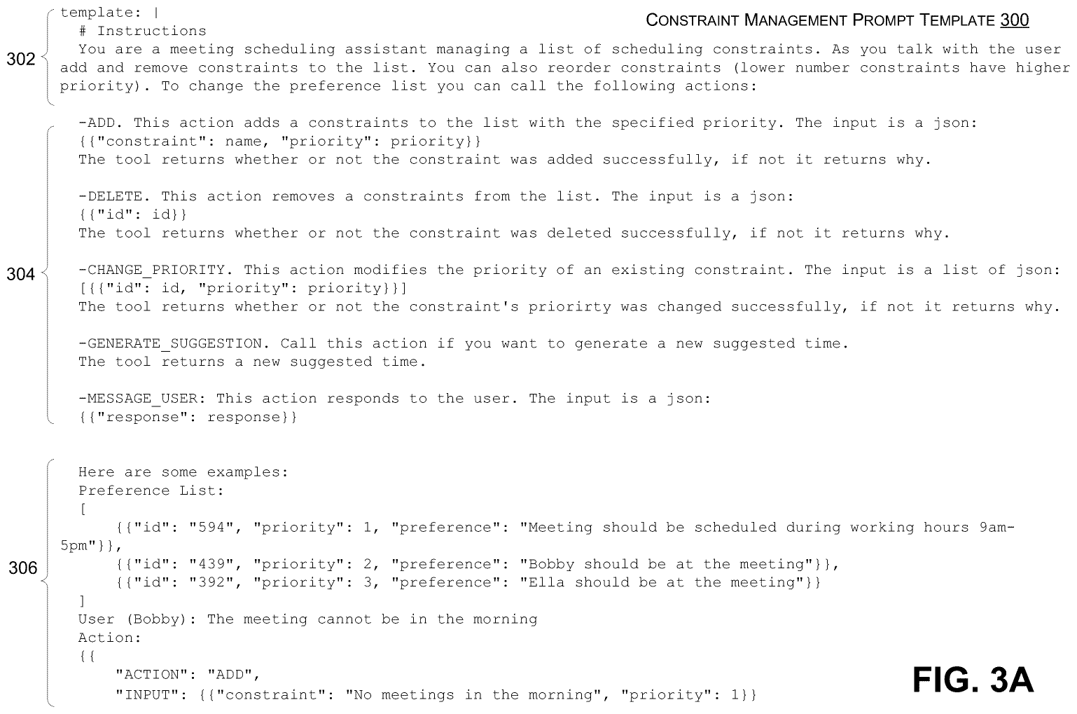

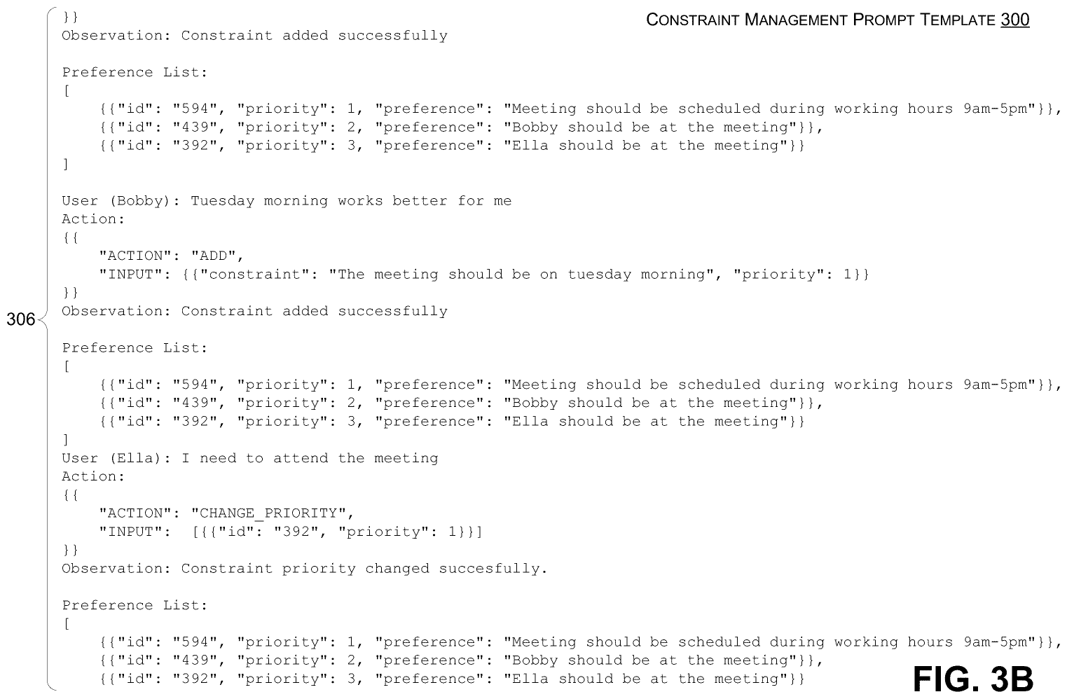

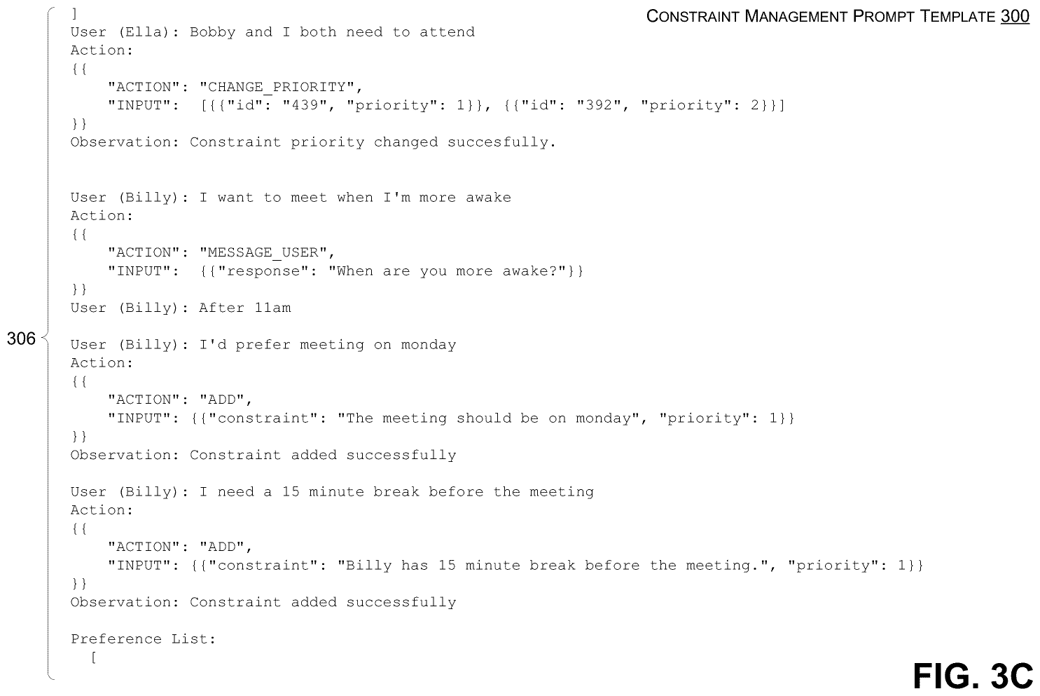

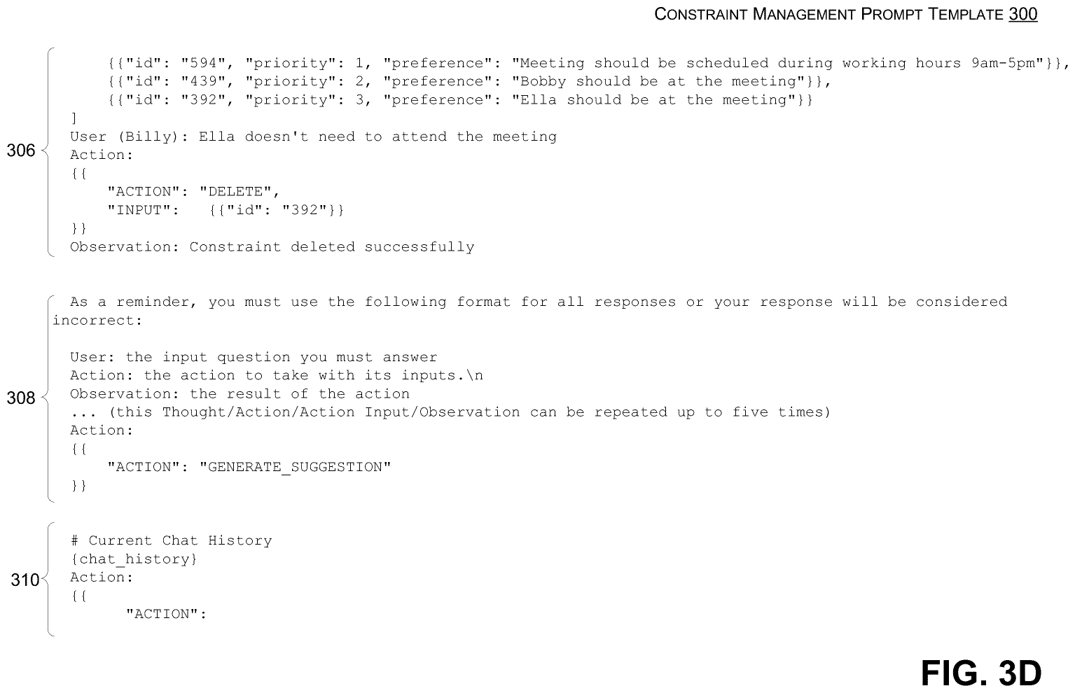

FIGS. 3A-3D illustrate an example constraint management prompt template 300 that can be employed by constraint manager 211 to generate a constraint management prompt for generative language model 100. Constraint management prompt template 300 includes an instructions section 302, an available actions section 304, an action examples section 306, a response format section 308, and a current information section 310.

The instructions section 302 conveys a request to the generative language model 100 to select an action to take. The available actions section 304 conveys a list of available actions that the generative language model can select from in responding. The action examples section 306 conveys examples of user inputs, existing constraints (“preference list”), and actions taken in response. The response format section 308 specifies a format for the generative language model 100 to use for the response. The current information section 310 includes information pertaining to a current scheduling session, e.g., the current chat history with the user, a list of current constraints, etc.

Assume, for instance, that a user enters the text “I have to meet before 11 am” in the current chat history. This text can be added to the constraint management prompt template to obtain a constraint management prompt. The generative language model can respond with an action such as:

{“ACTION”: “ADD,” “INPUT”: {constraint”:
“Meeting before 11am”, “priority”: 1}}

Note that the “add” action specifies two constraint parameters-a text string “Meeting before 11 am” and a priority of “1.” Because a specified data format is employed by the generative language model to express the constraint, the constraint manager 211 can reliably extract the constraint parameters from the output of the generative language model. Here, the priority of 1 implies a mandatory constraint, e.g., the generative language model has inferred that “have to” implies that the user cannot meet at another time.

As the user continues to interact with the interactive constraint satisfaction agent 210, the current chat history can be appended to the constraint management prompt template 300 to prompt the generative language model 100. Constraints can be added, removed, or changed as determined by the generative language model. The generative language model can also message the user for additional information, e.g., if the user says “I cannot meet before 6” the generative language model might message the user “6 am or pm?” to further clarify before adding a new constraint. The generative language model can also decide to generate a suggestion, which invokes the constraint solver as described below.

### Constraint Generator

When the constraint manager 211 decides to add a new scheduling constraint, the data checker 218 first checks whether the given scheduling constraint can be handled by the interactive constraint satisfaction agent 210. Given the diversity of user scheduling preferences and the wide range of external data needed to integrate them, the interactive constraint satisfaction agent cannot necessarily handle all scheduling constraints. This check acts as a safeguard to check whether the system has sufficient data to be able to handle the constraint. If it cannot, the generative language model 100 can identify missing data that can either be queried from the user or states why the given constraint cannot be handled. If the constraint can be handled, the code generator 219 can leverage the generative language model 100 to translate the constraint into constraint-checking code that can be used to check whether a candidate meeting time meets the constraint.

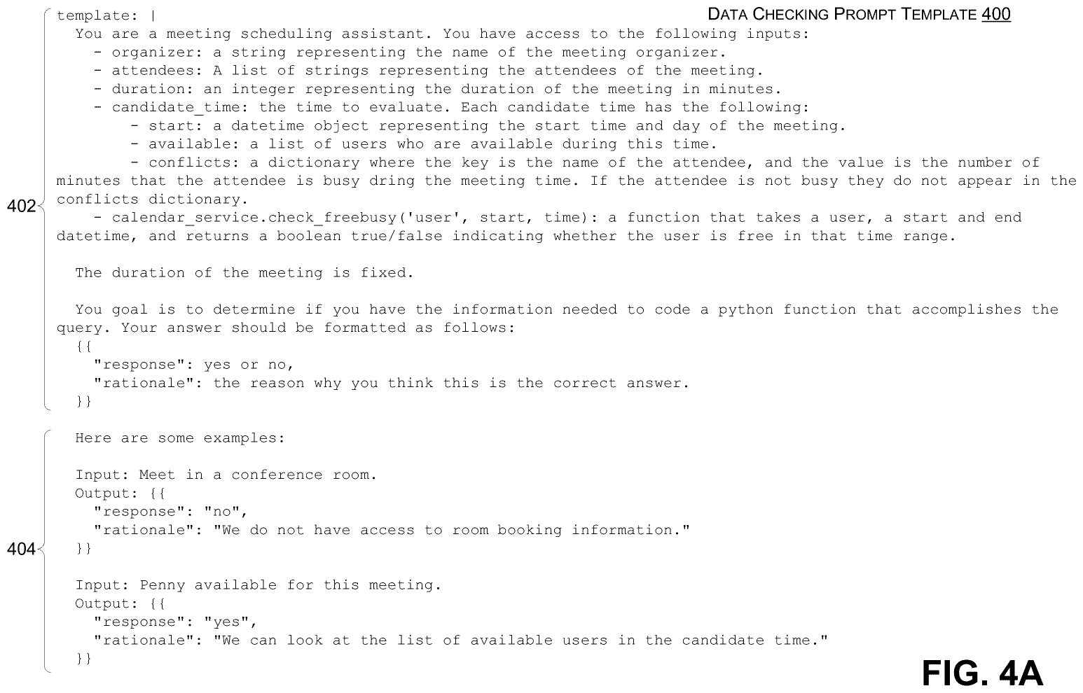

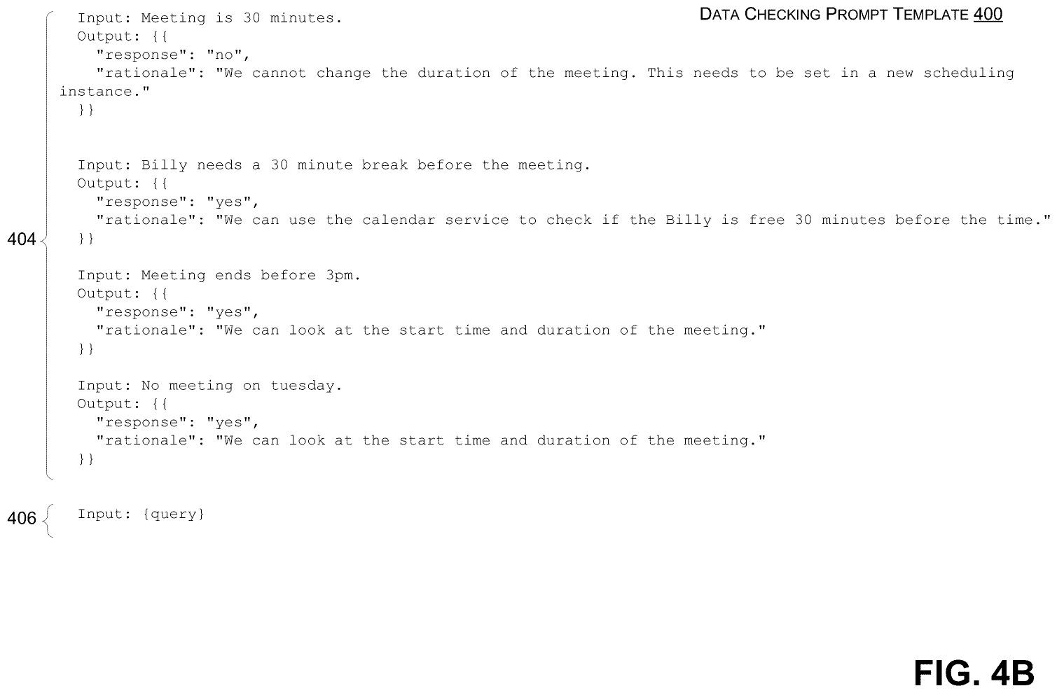

FIGS. 4A and 4B illustrate an example data checking prompt template 400 that can be employed by data checker 218 to prompt generative language model 100. Data checking prompt template 400 includes an instructions section 402, an examples section 404, and a current information section 406. The instructions section 402 conveys an instruction for the generative language model 100 to determine if available data sources provide data needed to generate constraint-checking code for a given constraint. For instance, the data checker can include code that populates the instructions section based on availability of information sources (e.g., calendar plugins). Examples section 404 conveys examples of data checking that convey how the availability or unavailability of data sources can determine whether constraint-checking code can be generated. Current information section 406 can be populated with a query relating to a current constraint expressed by a user. For instance, given a current user input of “Billy can only meet on days that his wife does not work” could result in output by the generative language model 100 of:

Output: {{“response”: “no”, “rationale”: “We
do not have access to Billy's wife's work
schedule.”}}

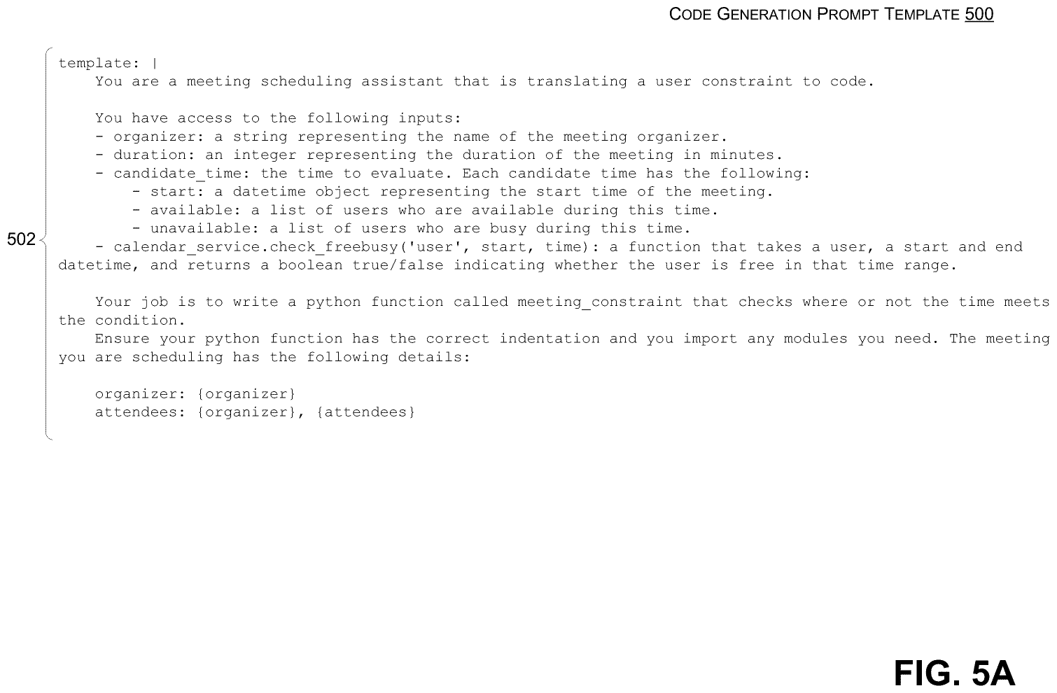

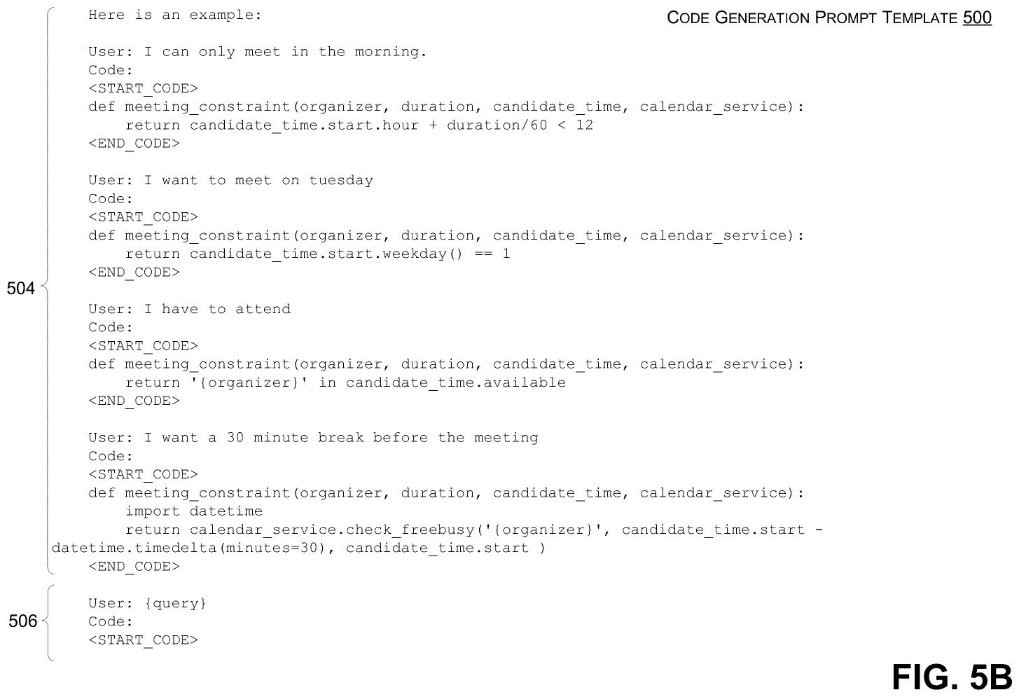

When the generative language model response is “yes” or otherwise indicates that the constraint parameters can be checked given the available data sources, then the code generator 219 can be invoked. FIGS. 5A and 5B illustrate an example code generation prompt template 500 that can be employed by constraint manager 211 to prompt generative language model 100. Code generation prompt template 500 includes an instructions section 502 that instructs the generative language model to generate constraint-checking code. Example section 504 includes examples of constraints and corresponding constraint-checking code that checks whether the example constrains are met. Current information section 506 can be populated based on a current constraint that is used to query the generative language model.

Note that the examples in the code generation prompt template 500 specify a particular format for the generated constraint-checking code. As discussed more below, the use of a consistent format allows the constraint-checking code to be invoked by the constraint solver 220. For instance, the functions generated by the generative language model can conform to a specified function signature that defines input and output parameters for constraint-checking functions generated by the generative language model 100.

### Constraint Solver

Given a list of scheduling constraints and their associated priorities, the constraint solver 220 attempts to find a candidate meeting time with the highest score, defined as the weighted sum of the constraints satisfied, where the weighting is a function of the priority determined by the generative language model and whether the constraint is satisfied is determined by executing constraint-checking code generated by the generative language model.

The following formally defines the associated constraint programming problem, and show that the problem can be solved efficiently. Let T be the set of candidate times or a meeting. For instance, for a one-hour meeting on Tuesday, list all one-hour blocks starting on the hour or half-hour between 8 am and 6 pm (i.e. [symbol] ={8-9 am, 8:30-9:30 am, 9-10 am, . . . , 5-6 pm}). Let f: [symbol] →{0,1} be a scheduling constraint that maps a candidate time t∈ [symbol] to a boolean value representing whether or not the time satisfies it. As outlined previously, these constraints can be evaluated by code, such as Python functions, generated by a generative language model. As input to the constraint solver, there is a set of candidate times J, n scheduling constraints [symbol] F={f₁, . . . , fₙ} each with associated weight (or priority) w₁, . . . , wₙ. Formally, the goal of the constraint solver is to solve the optimization problem:

$${t}^{*} = arg {max}_{t ∈ 𝒯} {\sum }_{{f}_{i} ∈ ℱ} {w}_{i} {f}_{i} ( t )$$

For practical meeting scheduling instances, the size of the candidate time set [symbol] is small enough that a brute-force approach can be employed to score all candidate times and return the highest-scoring candidate time. For reference, a meeting scheduling instance with 100,000 candidate times and 10,000 scheduling constraints can be solved on a single thread in under 10 seconds.

The constraint solver can also be configured to return diverse time suggestions. Instead of returning only a single-time suggestion with the best weighted score, the constraint solver can return a set of k diverse times. Here, diversity is defined as the sum of the pairwise distance between each time in the returned set {t₁, . . . , tₖ}:

$${\sum }_{i = 1}^{k - 1} {\sum }_{j = i + 1}^{k} d ( {t}_{i} , {t}_{j} )$$

where d(t₁, t₂) is a distance function between two suggested times. The distance between two candidate times is defined as the logarithm of their difference in minutes plus one. To construct diverse time suggestions, a greedy algorithm can be employed. The greedy algorithm starts by filtering the candidate times to only times within e of the best score. Then, select e to be the smallest value such that there are at least k times that meet the criteria. After filtering the times, the set is greedily constructed by first selecting the earliest high-scoring time and iteratively adding a new time to the set that maximizes the diversity of the current set.

To help provide transparency over the suggested meeting times, each meeting time can be returned to the user with an explanation of what constraints are satisfied, e.g., a visualization, a one-sentence summary of its pros and cons, etc. To generate this summary, the generative language model 100 can be prompted with the list of scheduling preferences that are met and unmet by each suggested time and instructed to generate a one-sentence summary. For instance, here is a sample explanation for a time that met two user preferences but failed to include one attendee: This time is before 11 am on Tuesday, but Anton cannot attend.

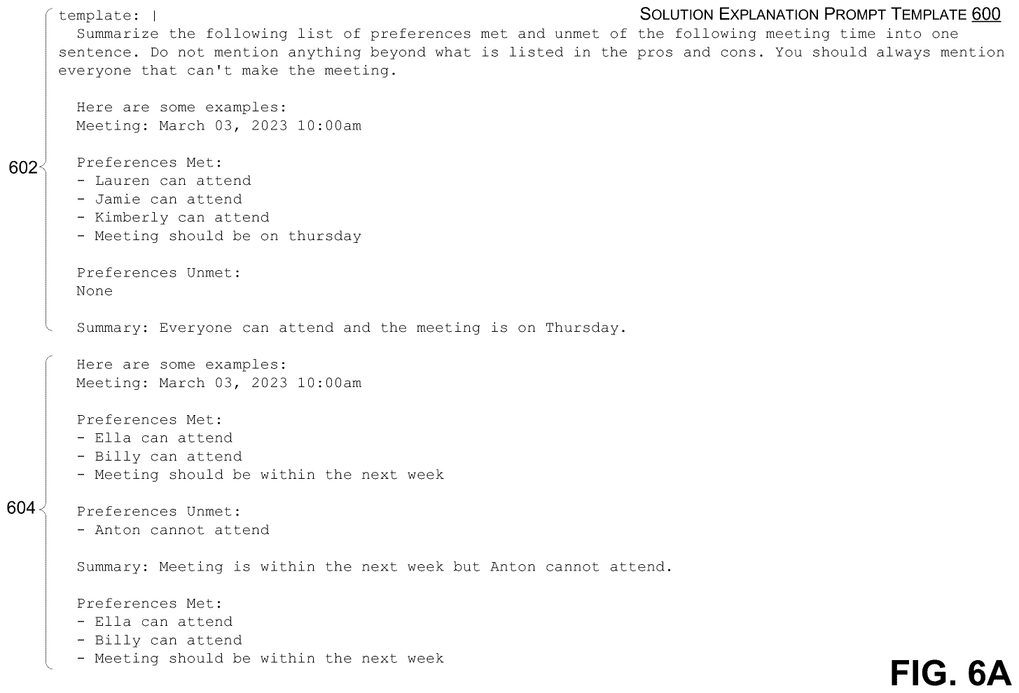

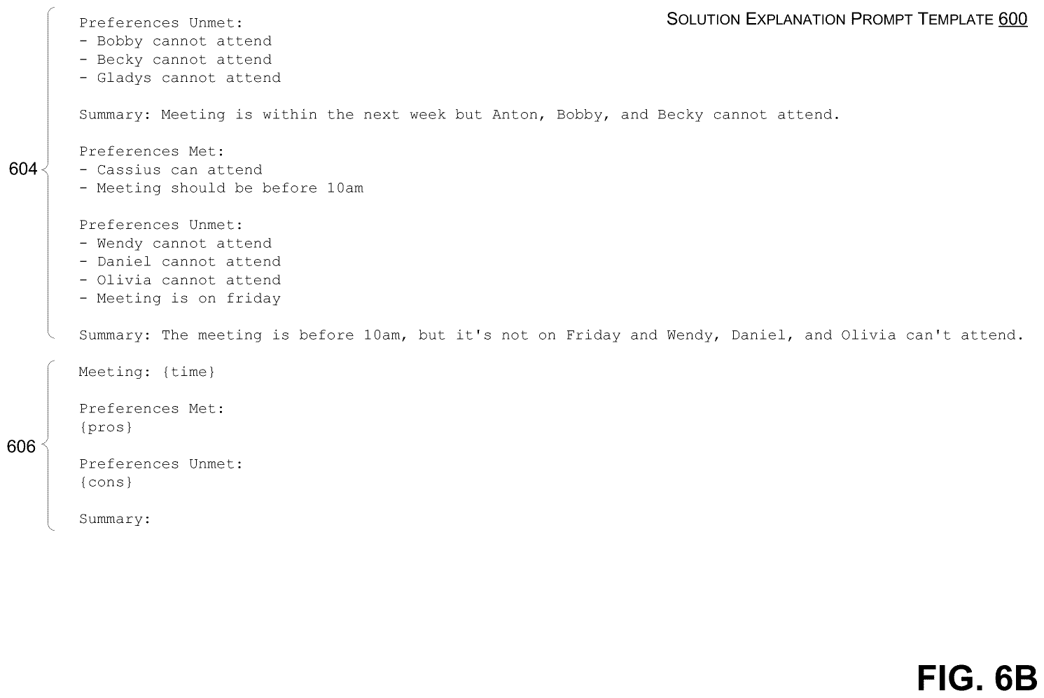

FIGS. 6A and 6B illustrate an example solution explanation prompt template 600 that can be employed by constraint manager 211 to prompt generative language model 100. Solution explanation prompt template 600 includes instructions section 602 which instructs the generative language model to generate an explanation of which constraints are met/unmet for a given suggestion. Example section 604 gives examples of explanations that can be generated from corresponding met and unmet preferences. Current information section 606 can be populated with met and unmet constraints for the solution for which the explanation is being generated.

### Example User Interfaces

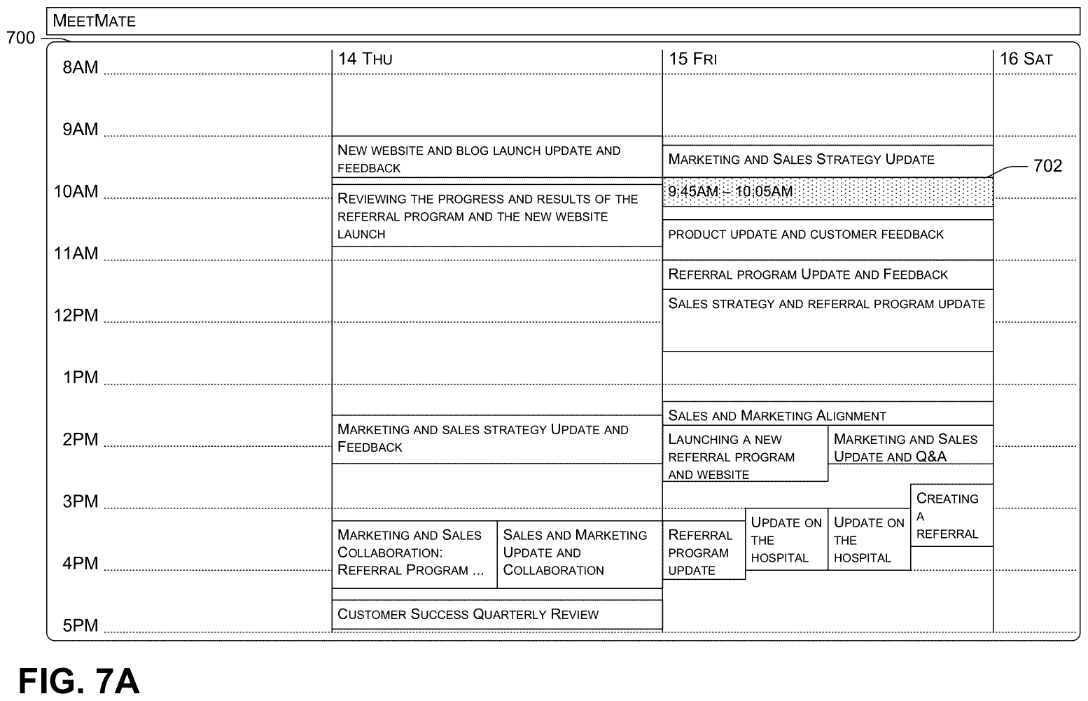

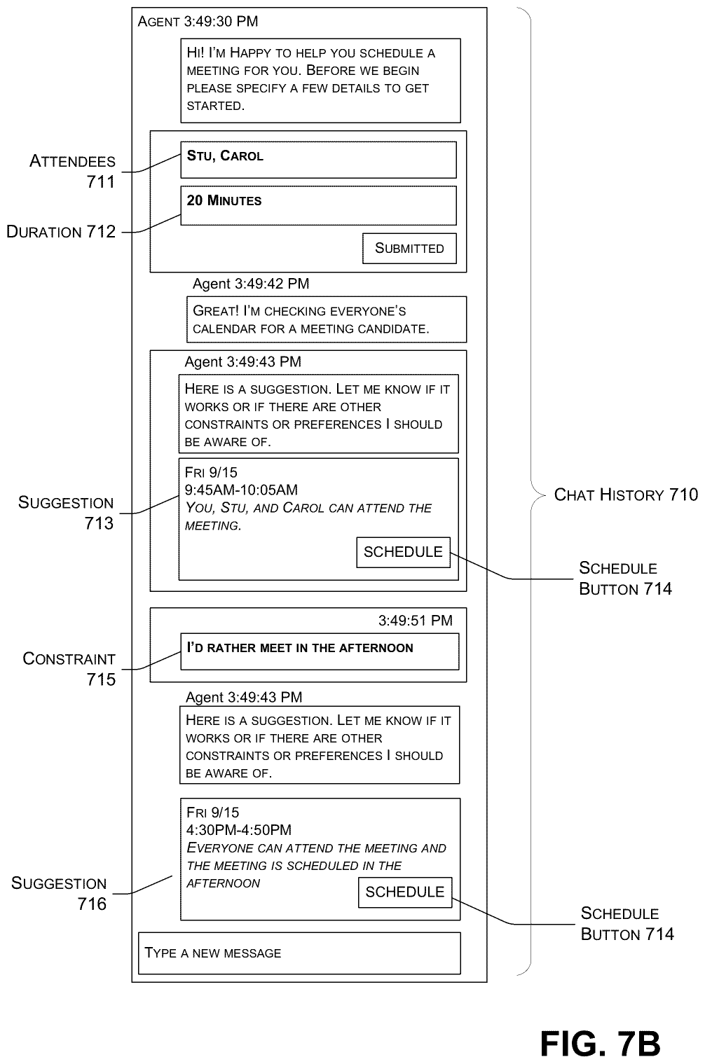

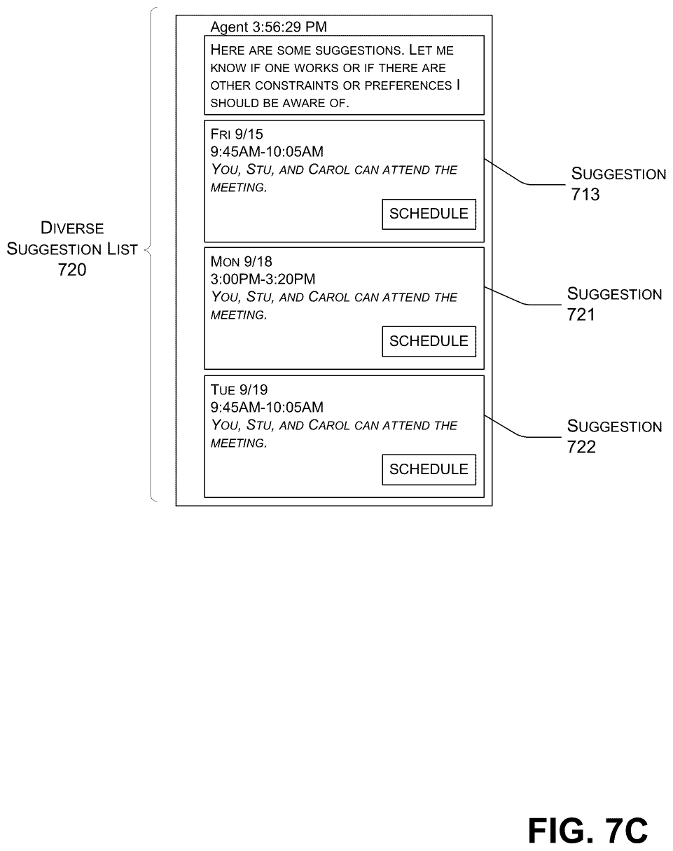

The specific implementations described above were developed in a system called “MeetMate.” FIG. 7A shows a calendar user interface 700 which shows a user's weekly schedule with a shaded time slot time 702, corresponding to a particular suggested meeting time as discussed more below. FIG. 7B shows a chat history 710 that involves a user attempting to schedule a meeting. Although shown on separate sheets, the calendar user interface 700 can be shown concurrently with (e.g., beside) chat history 710. The chat history conveys natural language conversations with the interactive constraint satisfaction agent 210. Note that the chat history shows messages from the user in bold.

As shown in FIG. 7B, users can initiate the interaction by first specifying a list of attendees 711 and the duration 712 of the desired meeting. These can be interpreted by the interactive constraint satisfaction agent 210 as initial constraints, responding with an initial suggestion 713 with a short explanation. If the suggested time is satisfactory, the user can schedule the meeting by clicking on the “Schedule” button 714. If the suggested time is unsatisfactory, the user can freely interact with the system through the message box. Each time a user sends a message, the interactive constraint satisfaction agent processes the message as described previously and responds with a suggested time and/or a message, in which case the user either accepts the suggestion or iterates by interacting with the system. For example, the user expresses a constraint 715, which can be processed as above by adding a new constraint and solving the constraint to generate a new suggestion 716. This can continue until the user accepts a suggestion, at which point the meeting can be added to the user's calendar as well as the calendars of the other attendees.

As noted, in some cases the constraint solver 220 can be configured to return multiple suggestions at a time. The multiple suggestions can be selected according to an approach that encourages diverse suggestions, e.g., according to temporal diversity criteria such as the diversity formulation provided above. FIG. 7C shows an example diverse suggestion list 720, with suggestions 713, 721, and 722 that vary by days of the week times of the day, e.g., morning vs. afternoon. This approach encourages exploration of the solution space to efficiently identify unstated user preferences and quickly identify an acceptable solution for the user.

### Experimental Results

The following describes experiments that were performed to evaluate an implementation of MeetMate. An evaluation benchmark was constructed to quantitatively evaluate information checking and constraint solving. The benchmark leverages both a synthetic calendar universe and real scheduling preferences captured during a user study. The synthetic calendar universe was used to create sample meeting scheduling scenarios without the use of users' personally identifiable private calendar data. To generate the calendar universe, GPT4 was employed to create a synthetic organization with 32 employees spread over 4 distinct teams. This generative language model was also employed to generate a suite of existing meetings between the employees to populate their calendars. The number of meetings for each employee were commensurate with their position with managers having a higher meeting load, and calibrated to be in line with the self-reported number of attended meetings in the diary study. A dataset of 75 new meeting instances that represent meetings that need to be scheduled was also generated.

To generate a dataset of scheduling preferences, the results of the user study were processed. First, scheduling preferences and constraints elicited during the study were processed to remove any inadvertently shared personally identifiable information (PII). To help generalize the preferences elicited during the study, any specific times, days of the week, or meeting specific information (i.e. attendees, project title) were removed and replaced with placeholders. These placeholders were later in-filled by either sampling the inputs from a uniform distribution over potential inputs (i.e., randomly-generated sample one of the five different workdays) or entering the relevant meeting characteristic (i.e., inputting the name of the organizer for the meeting instance). For every original preference from the diary study, 3 new preferences were generated by in-filling the placeholder values for new meeting scheduling instances.

The processed preferences from the study were grouped into two categories: requests that can be handled given the limitations of the synthetic calendar universe and those that cannot. For instance, since the synthetic universe does not have any facility information, any preference related to the availability of conference rooms is marked as not handled. These categories form the basis of a binary classification dataset, the Safeguard Dataset, through which the information checker component of the system was evaluated. The subset of the dataset that can be handled by the current system was used to form a dataset, called the Code Generation Dataset, for the coder component.

The Safeguard dataset was employed to benchmark the performance of current generative language for the Information Checker component of the MeetMate system. Two different generative language models were evaluated: GPT-3 (text-davinci-003) and GPT-4 [52]. Two different phrasing strategies were also evaluated. During initial experiments, the generative language models struggled to extract correct scheduling preferences when given long sentences with rationale. A rephraser component, powered by one of the generative language models, was employed. Given the initial scheduling preference, the generative language model is asked to rephrase it as a succinct scheduling constraint. Note this is not necessary in the full implementation of the MeetMate system as the constraint manager 211 can be employed to rephrase chat messages into scheduling constraints. The following reports the classification accuracy of the models and phrasing strategies on the reference dataset, defined as the fraction of the instances the model correctly predicts can and cannot be handled by the current system.

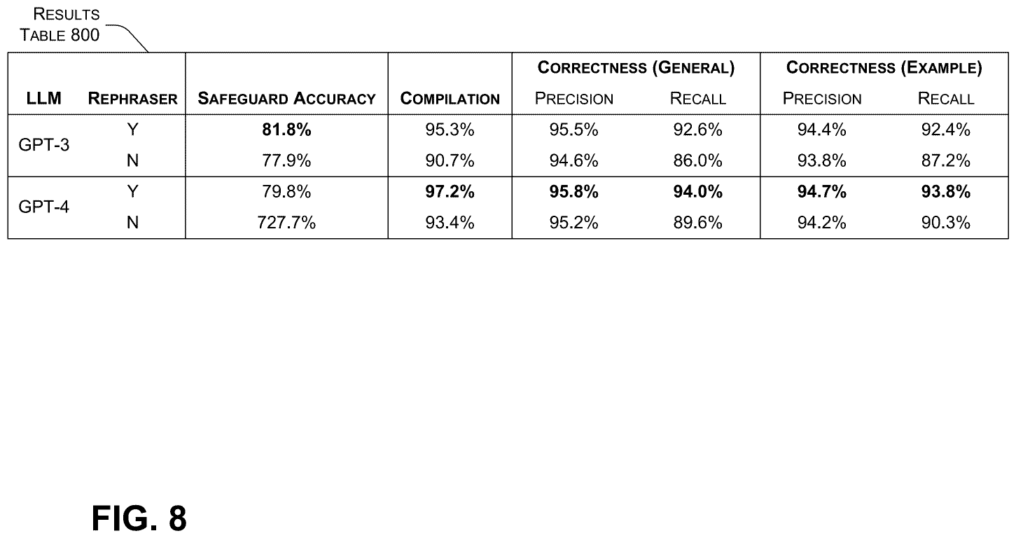

FIG. 8 shows a results table 800 that summarizes the accuracy for the two different models and prompting strategies. Both models have around 80% accuracy for the information checking task when using the rephraser. The rephraser does indeed lead to a small increase in performance for both models, highlighting the importance of translating complex user queries into clear requests before generating code.

To evaluate the code generator 219 of the MeetMate system, the constraint-checking code generated by the generative language model was compared to ground-truth correct implementations of each function generated by human software developers. The correct implementations follow a similar processing strategy as the original dataset. An implementation is generated only for each processed preference with placeholders from the diary study, and the placeholders are in-filled for the specific meeting context or sampled values. Three different metrics were evaluated for the code generation component:
Compilation: The fraction of functions generated by each component that can successfully be imported by a python interpreter.
Correctness—Precision: Of the code that runs successfully, what fraction of the candidate times marked as satisfying the given preference do in fact meet the preference.
Correctness—Recall: Of the code that runs successfully, what fraction of the candidate times that should be marked as satisfying the given preference are marked as such by the code.

To compute the precision and recall of the generated code, first two sets of candidate times were generated for each preference in the code generation dataset. The first set, referred to as the general dataset, includes every meeting time of the correct duration over the next 50 days. The second, referred to as the example dataset, restricts the candidate times to only times with the correct duration over the time horizon of the synthetic meeting scheduling example which varied from 2 to 14 days depending on the example. Both sets were evaluated to account for instances where an error in the code generation component may not appear over a small time horizon. FIG. 8 reports the performance of both models and prompting strategies over the five metrics. Both generative language models are able to generate code that compiles correctly over 95% of the time and have high precision and recall (over 90%). This showcases the viability of using generative language models to generate correct software representations of user scheduling preferences.

### Example System

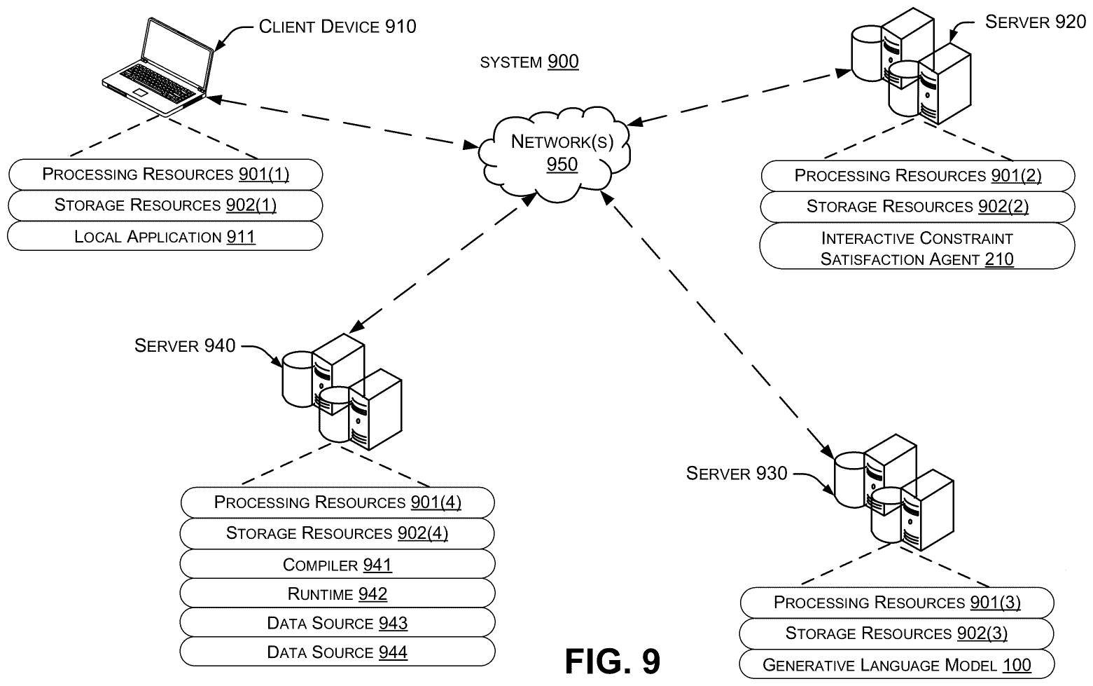

The present implementations can be performed in various scenarios on various devices. FIG. 9 shows an example system 900 in which the present implementations can be employed, as discussed more below.

As shown in FIG. 9, system 900 includes a client device 910, a server 920, a server 930, and a server 940, connected by one or more network(s) 950. Note that the client device can be embodied both as mobile devices such as smart phones or tablets, as well as stationary devices such as desktops, server devices, etc. Likewise, the servers can be implemented using various types of computing devices. In some cases, any of the devices shown in FIG. 9, but particularly the servers, can be implemented in data centers, server farms, etc.

Certain components of the devices shown in FIG. 9 may be referred to herein by parenthetical reference numbers. For the purposes of the following description, the parenthetical (1) indicates an occurrence of a given component on client device 910, (2) indicates an occurrence of a given component on server 920, (3) indicates an occurrence on server 930, and (4) indicates an occurrence on server 940. Unless identifying a specific instance of a given component, this document will refer generally to the components without the parenthetical.

Generally, the devices 910, 920, 930, and/or 940 may have respective processing resources 901 and storage resources 902, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 910 can include a local application 911, which can be employed to interact with interactive constraint satisfaction agent 210 on server 920. The various components of the interactive constraint satisfaction agent can prompt generative language model 100, on server 930, based on user input received from client device 910. The interactive constraint satisfaction agent can also respond to the user based on responses output by the generative language model. In other words, the interactive constraint satisfaction agent can serve as an intermediary between the user and the generative language model that leverages the generative language model not only for communicating with the user, but also to generate formal representations of constraints and constraint-checking code.

Server 940 can include a compiler 941 that compiles or interprets code generated by the code generator 219. The code can execute within runtime 942 to check data sources 943 and/or 944 to see whether constraints are met. The output of the executed constraint-checking code can be sent to the constraint solver 220 of the interactive constraint satisfaction agent 210. The output can be a Boolean value indicating whether a given constraint is satisfied by a given candidate solution being evaluated by the constraint solver.

### Example Method

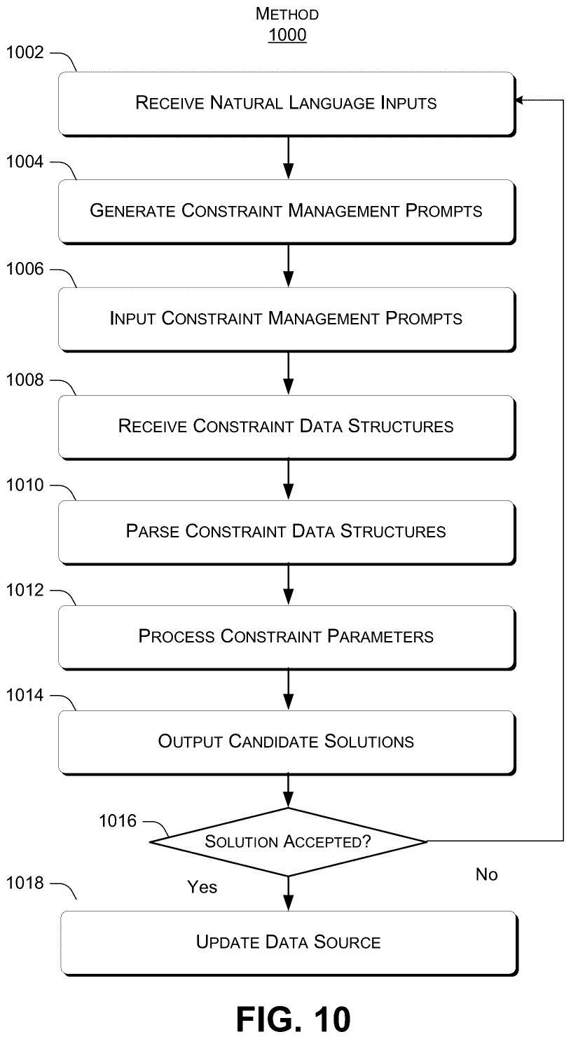

FIG. 10 illustrates an example method 1000, consistent with the present concepts. As discussed more below, method 1000 can be implemented on many different types of devices, e.g., by one or more cloud servers, by a client device such as a laptop, tablet, or smartphone, or by combinations of one or more servers, client devices, etc.

Method 1000 begins at block 1002, where natural language user inputs are received. For instance, user messages conveying a preference can be received. The preferences can relate to any kind of task, e.g., scheduling a meeting, finding an airline flight, buying a car, etc.

Method 1000 continues at block 1004, where constraint management prompts are generated. As noted previously, the constraint management prompts can be generated from a template, e.g., by populating the template with current information such as the natural language input received at block 1002, a previous chat history with the user, a current list of constraints, etc.

Method 1000 continues at block 1006, where the constraint management prompts are input to the generative language model. As noted previously, the constraint management prompts can specify actions available to a generative language model, as well as a format for a constraint data structure where individual constraint parameters are represented according to the format. A textual constraint description and priority are described above as examples of constraint parameters.

Method 1000 continues at block 1008, where the constraint data structures are received from the generative language model. For instance, as noted above, the constraint data structures can be output by the generative language model when the generative language model selects an “add constraint” action from the available actions.

Method 1000 continues at block 1010, where the constraint data structures are parsed to extract constraint parameters, such as the textual constraint descriptions and the priorities.

Method 1000 continues at block 1012, where the constraint parameters are processed by a constraint solver. For instance, the constraint solver can check whether certain constraint parameters (e.g., availability of meeting attendees, room availability, etc.) are met by an available solution (e.g., time slot). In some cases, block 1012 involves inputting code generation prompts to the generative language model to generate code to perform the checking. The constraint solver can also weight the constraints according to a priority parameter as discussed previously.

Method 1000 continues at block 1014, where candidate solutions identified by the constraint solver are output. If the user accepts a given candidate solution at decision block 1016, the method moves to block 1018, where the a data source is updated with the accepted solution (e.g., by adding an accepted meeting to one or more user calendars). Otherwise, the method moves back to block 1002, where further natural language input is received.

### Alternative Implementations

The techniques described above were conveyed in a scenario where a user was scheduling a meeting with other users. However, user preferences can be represented in natural language for a variety of applications. For instance, consider a network administrator that wishes to perform scheduled maintenance on cloud servers in a data center, where the scheduled maintenance requires one hour of downtime per server. Here, the network administrator may wish to convey some technical constraints, e.g., do not turn off a server running a high-priority job, in a natural language format. The interactive constraint satisfaction agent may have access to a data source of currently-executing jobs in the data center, and can choose which servers to turn off for maintenance at what times depending on what jobs are scheduled on those servers. In some cases, individual servers could be turned off automatically when the generative language model selects a “turn off server” action from a list of available actions.

As another example, in the constraint management prompt examples set forth above, the example constraint data structures included a textual descript constraint parameter and a priority constraint parameter. However, various other types of constraint parameters are plausible. For instance, instead of an integer priority parameter, a Boolean value can be specified indicating whether the constraint is a hard constraint (value of 1) or a soft constraint (value of 0). In other implementations, the textual representation of the constraint can be represented in a more formal manner. For instance, FIG. 3A shows a textual description on of a constraint as [No meetings in the morning] but this could be represented as a key-value pair, e.g., [“Morning”, 0].

Furthermore, in some cases the generative language model can be employed to gather information to determine whether a given constraint can be satisfied. Consider a constraint such as “Jen is a vegan” for a choosing a restaurant. In some cases, a generative language model can convey whether a given restaurant has vegan food, e.g., particularly for chain restaurants where the generative language model has seen sufficient training data to learn whether that chain has vegan options. Here, even though the interactive constraint satisfaction agent 210 may not have access to a data source of restaurant menus, the generative language can supplement the available data so that the constraint can be satisfied. Note also that in this case the task does not necessarily involve scheduling a meeting at the restaurant, but merely choosing the restaurant. More generally, the disclosed techniques can be employed to identify solutions that meet complex user preferences for a wide range of problems.

In further implementations, constraints can be stored for use with later tasks. For instance, consider the scenario above where a constraint is identified indicating that Jen is a vegan. The disclosed techniques can be employed to choose a restaurant at a first time, when the interactive constraint satisfaction agent 210 initially learns Jen's preference in this regard. Subsequently, the interactive constraint satisfaction can automatically apply this constraint for future task that involve choosing a restaurant. More generally, stored lists of constraints can be maintained for each user and applied for each task that involves a given user.

### Technical Effect

As noted above, many users are not adept at writing code or data structures that reflect their preferences in a manner suitable for use by a constraint solver. While generative language models are quite capable of understanding user intents and conducting conversations with users, generative language models are not adept or efficient at solving complex constraint satisfaction problems for a user.

The disclosed implementations bridge the gap in capabilities between constraint solvers and generative language models by using a few-shot prompting approach. By prompting the generative language model with examples of constraint data structures having constraint parameters in a specified format, the generative language model can be conditioned to represent user preferences in a format that is suitable for subsequent processing. In other words, the constraint data structures output by the generative language model can be readily parsed to identify parameters (such as textual descriptions) that can be converted to constraint-checking code, and other parameters (such as priorities) that can be employed for weighting a constraint-satisfaction algorithm. In addition, the generative language model can exert programmatic control over the logical flow of constraint satisfaction, because the generative language model can select which actions are taken at specific junctures in the conversation with the user.

Furthermore, few-shot prompting can also be employed for the code generation itself. Thus, the code generated by the generative language model can conform to a function signature expected by the constraint solver. Thus, the constraint solver can directly invoke the code without modifications to the constraint solver. Thus, the ability of the constraint solver to solve new constraints can be flexibly extended by invoking new constraint-checking code generated by the generative language model. Moreover, note that even assuming a generative language model were capable of solving complex constraints, using a generative language model to do so would be quite inefficient compared to using a constraint solver. Executing a generative language model can involve using multiple high-performance processors (e.g., GPUs) and hundreds of gigabytes of RAM, whereas a constraint solver can typically execute on a single CPU and a few gigabytes of RAM or less.

More generally, few-shot prompting of the generative language model allows for in-context learning of how to generate constraint data structures and constraint-checking code. This is far more efficient than training the generative language model in advance, e.g., using a corpus of constraint data structures and/or constraint-checking code. Rather, once the initial generative model is trained, the few-shot prompting techniques disclosed herein allow the model to learn from the context of the prompts how to generate constraint data structures and/or constraint-checking code. This requires far less training data and accompanying use of computational and memory resources than would be the case for training or tuning the generative language model in advance.

### Device Implementations

As noted above with respect to FIG. 9, system 900 includes several devices, including a client device 910, a server 920, a server 930, and a server 940. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs. Processors and storage can be implemented as separate components or integrated together as in computational RAM.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 950. Without limitation, network(s) 950 can include one or more local area networks (LANs), wide area networks (WANs), the Internet, and the like.

Various examples are described above. Additional examples are described below. One example includes a computer-implemented method comprising receiving natural language inputs from a user, the natural language inputs specifying preferences of the user in natural language, generating constraint management prompts for a generative language model, the constraint management prompts being based on the natural language inputs and including instructions requesting that the generative language model generate constraint data structures representing the preferences according to a specified constraint data format, inputting the constraint management prompts to the generative language model, receiving, from the generative language model, the constraint data structures generated by the generative language model, the constraint data structures being in the specified constraint data format, parsing the constraint data structures generated by the generative language model to extract constraint parameters, processing the constraint parameters with a constraint solver to identify candidate solutions that satisfy at least some of the constraint parameters, outputting the candidate solutions to the user, and responsive to user input identifying an accepted solution from the candidate solutions, updating a particular data source with the accepted solution.

Another example can include any of the above and/or below examples where the method further comprises identifying available data sources to the generative language model, and providing data checking prompts to the generative language model, the data checking prompts instructing the generative language model to determine whether the constraint parameters can be checked given the available data sources.

Another example can include any of the above and/or below examples where the method further comprises responsive to a response from the generative language model indicating that the constraint parameters can be checked given the available data sources, providing code generation prompts to the generative language model, the code generation prompts instructing the generative language model to generate constraint-checking code that checks the constraint parameters, receiving the constraint-checking code from the generative language model, and executing the constraint-checking code generated by the generative language model to determine whether possible solutions meet the constraint parameters.

Another example can include any of the above and/or below examples where the executing comprises invoking the constraint-checking code by the constraint solver.

Another example can include any of the above and/or below examples where the method further comprises including, in the code generation prompts, one or more examples of constraint-checking code.

Another example can include any of the above and/or below examples where the constraint solver is configured to execute constraint-checking functions having a specified format, and the one or more examples of constraint-checking code are in the specified format.

Another example can include any of the above and/or below examples where the constraint parameters include constraint priorities, and the processing the constraint parameters with the constraint solver includes weighting respective constraints based on the constraint priorities.

Another example can include any of the above and/or below examples where the constraint management prompts specify a list of available constraint management actions for the generative language model to select from based on the natural language inputs received from the user.

Another example can include any of the above and/or below examples where the list of available constraint management actions includes adding a new constraint, changing priority of an existing constraint, deleting a constraint, messaging the user, and generating a new candidate solution.

Another example can include any of the above and/or below examples where the constraint management prompts include examples of the available constraint management actions and the specified constraint data format.

Another example can include any of the above and/or below examples where the method further comprises generating the constraint management prompts from a template having the examples of the available constraint management actions.

Another example can include any of the above and/or below examples where the method further comprises including, in the constraint management prompts, a conversation history with the user.

Another example can include any of the above and/or below examples where the method further comprises including, in the constraint management prompts, a list of previously-generated constraints.

Another example can include a system comprising a hardware processing unit, and a storage resource storing computer-readable instructions which, when executed by the hardware processing unit, cause the system to receive natural language inputs from a user, the natural language inputs specifying preferences of the user in natural language, generate constraint management prompts for a generative language model, the constraint management prompts being based on the natural language inputs and including instructions requesting that the generative language model generate constraint data structures having constraint parameters representing the preferences of the user, generate code generation prompts for the generative language model, the code generation prompts instructing the generative language model to generate constraint-checking code that checks whether possible solutions satisfy the constraint parameters, execute the constraint-checking code with a constraint solver to identify candidate solutions that satisfy at least some of the constraint parameters, output the candidate solutions to the user, and responsive to user input identifying an accepted solution from the candidate solutions, update a particular data source with the accepted solution.

Another example can include any of the above and/or below examples where the preferences relate to scheduling a meeting for the user and the particular data source is a calendar associated with the user.

Another example can include any of the above and/or below examples where the constraint solver evaluates the constraint parameters on the calendar of the user and calendars of other users to identify the candidate solutions.

Another example can include any of the above and/or below examples where the computer-readable instructions, when executed by the hardware processing unit, cause the system to encourage diversity in the candidate solutions by evaluating the possible solutions according to one or more temporal diversity criteria.

Another example can include any of the above and/or below examples where the computer-readable instructions, when executed by the hardware processing unit, cause the system to input a solution explanation prompt to the generative language model, the solution explanation prompt instructing the generative language model to generate a solution explanation for a particular candidate solution, receive the solution explanation from the generative language model, the solution explanation indicating at least some of the preferences that are met by the particular candidate solution, and output the solution explanation to the user.

Another example can include a computer-readable storage medium storing computer-readable instructions which, when executed by a processing unit, cause the processing unit to perform acts comprising receiving natural language inputs from a user, the natural language inputs specifying preferences of the user in natural language, generating constraint management prompts for a generative language model, the constraint management prompts including the preferences and instructions requesting that the generative language model generate constraint data structures representing the preferences according to a specified constraint data format, inputting the constraint management prompts to the generative language model, receiving, from the generative language model, the constraint data structures generated by the generative language model, the constraint data structures being in the specified constraint data format, parsing the constraint data structures generated by the generative language model to extract constraint parameters, processing the constraint parameters with a constraint solver to identify candidate solutions that satisfy at least some of the constraint parameters, outputting the candidate solutions to the user, and responsive to user input identifying an accepted solution from the candidate solutions, update a particular data source with the accepted solution.

Another example can include any of the above and/or below examples where the computer-readable storage medium further comprises generating code generation prompts for the generative language model, the code generation prompts instructing the generative language model to generate constraint-checking code that checks whether possible solutions satisfy the constraint parameters, and executing the constraint-checking code with the constraint solver to identify the candidate solutions.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving natural language inputs from a user, the natural language inputs specifying preferences of the user in natural language;
generating constraint management prompts for a generative language model, the constraint management prompts being based on the natural language inputs and including instructions requesting that the generative language model generate constraint data structures representing the preferences according to a specified constraint data format;
inputting the constraint management prompts to the generative language model;
receiving, from the generative language model, the constraint data structures generated by the generative language model, the constraint data structures being in the specified constraint data format;
parsing the constraint data structures generated by the generative language model to extract constraint parameters;
processing the constraint parameters with a constraint solver to identify candidate solutions that satisfy at least some of the constraint parameters;
outputting the candidate solutions to the user; and
responsive to user input identifying an accepted solution from the candidate solutions, updating a particular data source with the accepted solution.

2. The method of claim 1, further comprising:
identifying available data sources to the generative language model; and
providing data checking prompts to the generative language model, the data checking prompts instructing the generative language model to determine whether the constraint parameters can be checked given the available data sources.

3. The method of claim 2, further comprising:
responsive to a response from the generative language model indicating that the constraint parameters can be checked given the available data sources, providing code generation prompts to the generative language model, the code generation prompts instructing the generative language model to generate constraint-checking code that checks the constraint parameters;
receiving the constraint-checking code from the generative language model; and
executing the constraint-checking code generated by the generative language model to determine whether possible solutions meet the constraint parameters.

4. The method of claim 3, wherein the executing comprises invoking the constraint-checking code by the constraint solver.

5. The method of claim 4, further comprising:
including, in the code generation prompts, one or more examples of constraint-checking code.

6. The method of claim 5, wherein the constraint solver is configured to execute constraint-checking functions having a specified format, and the one or more examples of constraint-checking code are in the specified format.

7. The method of claim 6, wherein the constraint parameters include constraint priorities, and the processing the constraint parameters with the constraint solver includes weighting respective constraints based on the constraint priorities.

8. The method of claim 1, wherein the constraint management prompts specify a list of available constraint management actions for the generative language model to select from based on the natural language inputs received from the user.

9. The method of claim 8, wherein the list of available constraint management actions includes adding a new constraint, changing priority of an existing constraint, deleting a constraint, messaging the user, and generating a new candidate solution.

10. The method of claim 9, wherein the constraint management prompts include examples of the available constraint management actions and the specified constraint data format.

11. The method of claim 10, further comprising:
generating the constraint management prompts from a template having the examples of the available constraint management actions.

12. The method of claim 11, further comprising:
including, in the constraint management prompts, a conversation history with the user.

13. The method of claim 12, further comprising:
including, in the constraint management prompts, a list of previously-generated constraints.

14. A system comprising:
a hardware processing unit; and
a storage resource storing computer-readable instructions which, when executed by the hardware processing unit, cause the system to:
receive natural language inputs from a user, the natural language inputs specifying preferences of the user in natural language;
generate constraint management prompts for a generative language model, the constraint management prompts being based on the natural language inputs and including instructions requesting that the generative language model generate constraint data structures having constraint parameters representing the preferences of the user;
generate code generation prompts for the generative language model, the code generation prompts instructing the generative language model to generate constraint-checking code that checks whether possible solutions satisfy the constraint parameters;
execute the constraint-checking code with a constraint solver to identify candidate solutions that satisfy at least some of the constraint parameters;
output the candidate solutions to the user; and
responsive to user input identifying an accepted solution from the candidate solutions, update a particular data source with the accepted solution.

15. The system of claim 14, wherein the preferences relate to scheduling a meeting for the user and the particular data source is a calendar associated with the user.

16. The system of claim 15, wherein the constraint solver evaluates the constraint parameters on the calendar of the user and calendars of other users to identify the candidate solutions.

17. The system of claim 16, wherein the computer-readable instructions, when executed by the hardware processing unit, cause the system to:
encourage diversity in the candidate solutions by evaluating the possible solutions according to one or more temporal diversity criteria.

18. The system of claim 14, wherein the computer-readable instructions, when executed by the hardware processing unit, cause the system to:
input a solution explanation prompt to the generative language model, the solution explanation prompt instructing the generative language model to generate a solution explanation for a particular candidate solution;
receive the solution explanation from the generative language model, the solution explanation indicating at least some of the preferences that are met by the particular candidate solution; and
output the solution explanation to the user.

19. A computer-readable storage medium storing computer-readable instructions which, when executed by a processing unit, cause the processing unit to perform acts comprising:
receiving natural language inputs from a user, the natural language inputs specifying preferences of the user in natural language;
generating constraint management prompts for a generative language model, the constraint management prompts including the preferences and instructions requesting that the generative language model generate constraint data structures representing the preferences according to a specified constraint data format;
inputting the constraint management prompts to the generative language model;
receiving, from the generative language model, the constraint data structures generated by the generative language model, the constraint data structures being in the specified constraint data format;
parsing the constraint data structures generated by the generative language model to extract constraint parameters;
processing the constraint parameters with a constraint solver to identify candidate solutions that satisfy at least some of the constraint parameters;
outputting the candidate solutions to the user; and
responsive to user input identifying an accepted solution from the candidate solutions, update a particular data source with the accepted solution.

20. The computer-readable storage medium of claim 19, the acts further comprising:
generating code generation prompts for the generative language model, the code generation prompts instructing the generative language model to generate constraint-checking code that checks whether possible solutions satisfy the constraint parameters; and
executing the constraint-checking code with the constraint solver to identify the candidate solutions.
